(19) United States
(12) Patent Application Publication
(10) Pub. No.: US 2008/0195380 A1
(43) Pub. Date: Aug. 14, 2008

(54) Voice recognition dictionary construction apparatus and computer readable medium

(75) Inventor: Kenji Ogasawara, Tokyo (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Tokyo (JP)

(21) Appl. No.: 11/802,803

(22) Filed: May 25, 2007

(30) Foreign Application Priority Data
Feb. 9, 2007 (JP) 2007-030367

(51) Int. Cl. G06F 17/21; G10L 15/00

(52) U.S. Cl. 704/10; 704/244; 704/E15.001

(57) ABSTRACT

Disclosed is a voice recognition dictionary construction apparatus that includes a scanner unit to read a document; and a control unit to conduct character recognition of a term which is included in the document that has been read, and to update a dictionary for voice recognition in accordance with a result of the character recognition.

### CROSS-REFERENCE TO RELATED APPLICATIONS

The present U.S. patent application claims a priority under the Paris Convention of Japanese patent application No. 2007-030367 filed on Feb. 9, 2007, which shall be a basis of correction of an incorrect translation.

### BACKGROUND OF THE INVENTION

1. Field of the Invention

The present invention relates to a voice recognition dictionary construction apparatus that constructs or compiles a dictionary for voice recognition and a computer readable medium.

2. Description of Related Art

Due to recent recommendation of universal design, necessity for various kinds of operations to be conducted by voice input has increased with respect to various kinds of apparatuses such as a copy machine, a personal computer and the like. Accordingly, apparatuses that conduct processing in accordance with an operation command inputted by voice have been used more widely.

For example, with respect to a voice communication apparatus that recognizes what is inputted by voice of a user, selects a term to be directed to the user in accordance with the recognition result and outputs the selected term, an apparatus has been developed that inquires the user in a case where the user speaks a term that has not been pre-registered, stores the inquiry and a reply from the user, and uses the stored inquiry and reply in the communication thereafter (For example, refer to Japanese Patent Application Publication (Laid-open) No. 2004-109323).

However, in a case where various kinds of operations were instructed by voice input, voice recognition techniques had limitations. For example, with respect to a copy machine, recognition degree of limited general terms (“yes”, “no” and the like) and terms relating to specific operations (“punch”, “staple”, “mail” and the like) were able to be increased, however, recognition degree of voice related to proper nouns and special terms was difficult to be increased. Moreover, with respect to proper nouns and special terms, since terms that were used frequently differed in accordance with their environments for use, it was difficult to conduct voice recognition that was suitable for each environment for use.

### SUMMARY

The present invention has been made in view of the above problems with respect to the abovementioned prior techniques, and it is an object of the present invention to construct or compile a voice recognition dictionary that is suitable for an environment for use.

To achieve the abovementioned object, a voice recognition dictionary construction apparatus reflecting one aspect of the present invention comprises a scanner unit to read a document and a control unit to conduct character recognition of a term which is included in the document that has been read, and to update a dictionary for voice recognition in accordance with a result of the character recognition.

Preferably, the control unit determines a priority in a voice recognition of the term, in accordance with a number of times that the term has been character-recognized.

Preferably, the voice recognition dictionary construction apparatus further comprises an operation unit to receive input of a weighting value for a time when the document is read, wherein the control unit determines a priority in a voice recognition of the term, in accordance with the weighting value.

### BRIEF DESCRIPTION OF THE DRAWINGS

The present invention will become more fully understood from the detailed description given hereinafter and the accompanying drawings which are given by way of illustration only, and thus are not intended as a definition of the limits of the scope of the invention, and wherein:

FIG. 1 is a block diagram showing a function configuration of a copy machine 100 according to an embodiment of the present invention;

FIG. 2A is a view showing an example of a voice recognition dictionary 41;

FIG. 2B is a view showing a voice recognition dictionary 41 after reading a document 101;

FIG. 2C is a view showing a voice recognition dictionary 41 after reading a document 102;

FIG. 3 is a flowchart showing a processing of scan operation;

FIG. 4 is a flowchart showing a processing of voice recognition dictionary update;

FIG. 5A is a view showing the document 101;

FIG. 5B is a view showing the document 102;

FIG. 5C is a view showing the document 103;

FIG. 6 is a flowchart showing a processing of voice operation;

FIG. 7A is a flowchart showing a processing of voice recognition;

FIG. 7B is a flowchart showing a processing of voice recognition; and

FIG. 8 is a view showing a specific example of voice output of the copy machine 100 and voice input of the user with respect to the processing of voice operation.

### DETAILED DESCRIPTION OF THE PREFERRED EMBODIMENTS

Hereinafter, a copy machine 100 in accordance with an embodiment of the present invention will be described.

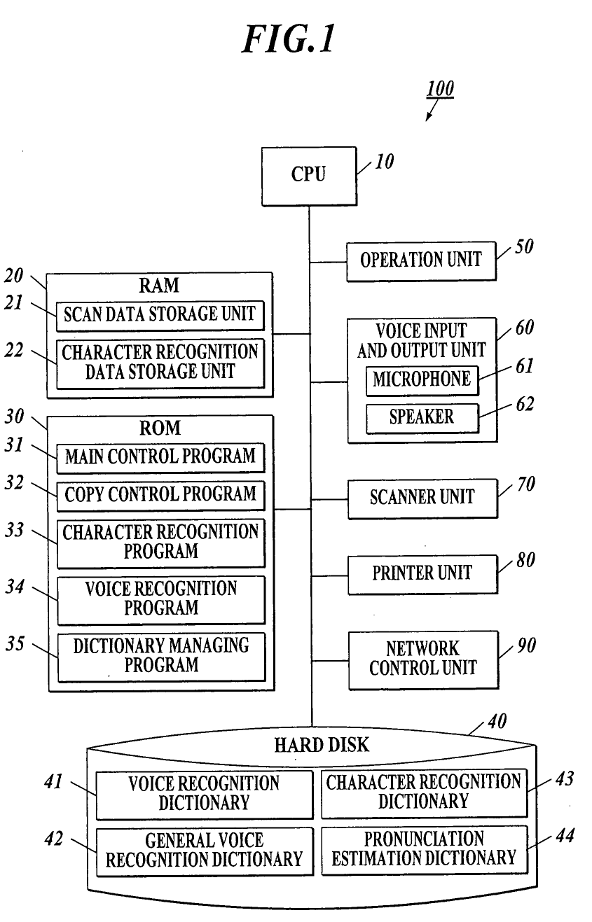

FIG. 1 is a block diagram showing a function configuration of the copy machine 100. As shown in FIG. 1, the copy machine 100 is structured with a Central Processing Unit (CPU) 10, a Random Access Memory (RAM) 20, a Read Only Memory (ROM) 30, a hard disk 40, an operation unit 50, a voice input and output unit 60, a scanner unit 70, a printer unit 80 and a network control unit 90, each unit being connected through a bus. The copy machine 100 is an apparatus that allows a user to instruct operation by uttering a voice.

The CPU 10 reads out various kinds of processing programs stored in the ROM 30 in accordance with an operation signal inputted from the operation unit 50, a voice signal inputted from the voice input and output unit 60 or an instruction signal received by the network control unit 90. The CPU 10 controls processing operation of each unit of the copy machine 100 in an integral manner, synergistically with the read out program.

Specifically, the CPU 10 controls the processing operation executed by the copy machine 100 in an integral manner, synergistically with a main control program 31 which is stored in the ROM 30.

The CPU 10 controls the scanner unit 70 or the printer unit 80, synergistically with a copy control program 32 which is stored in the ROM 30, and controls an operation of reading a document or an operation of copying. Image data which is obtained by reading the document with the scanner unit 70 (hereinafter referred to as scan data) is stored in a scan data storage unit 21 of the RAM 20.

The CPU 10 reads out the scan data from the scan data storage unit 21, and conducts character recognition (Optical Character Recognition: OCR) of a term included in the document by comparing the scan data with image patterns of characters that are registered in a character recognition dictionary 43 stored in the hard disk 40, synergistically with a character recognition program 33 stored in the ROM 30. Sequence of characters of the term which was character-recognized is stored in the character recognition data storage unit 22 of the RAM 20.

The CPU 10 analyzes a voice inputted from a microphone 61 of the voice input and output unit 60, and determines a term that corresponds to the inputted voice, from terms that are registered in a voice recognition dictionary 41 or a general voice recognition dictionary 42, synergistically with a voice recognition program 34 store in the ROM 30.

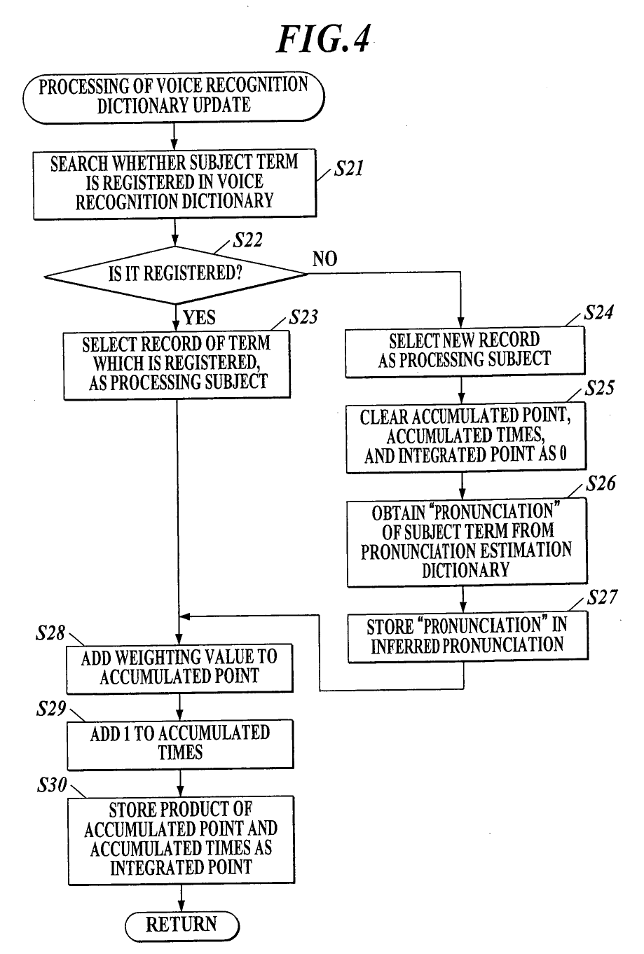

The CPU 10 executes a processing of voice recognition dictionary update (refer to FIG. 4) that updates the voice recognition dictionary 41 in accordance with the result of character recognition, synergistically with a dictionary managing program 35 which is stored in the ROM 30.

The RAM 20 forms a work area to temporally store various kinds of processing programs to be executed by the CPU 10 and data relating to these programs. The RAM 20 includes the scan data storage unit 21 and the character recognition data storage unit 22.

In the ROM 30, various kinds of programs that are executed by the CPU 10, such as a main control program 31, a copy control program 32, a character recognition program 33, a voice recognition program 34, a dictionary managing program 35 and the like are stored.

The hard disk 40 is a memory device that stores various kinds of data, and is stored with the voice recognition dictionary 41, the general voice recognition dictionary 42, the character recognition dictionary 43, a pronunciation estimation dictionary 44, and the like.

The voice recognition dictionary 41 is a dictionary for voice recognition that is updated by the use of the copy machine 100. Here, the voice recognition dictionary 41 can be stored in the RAM 20.

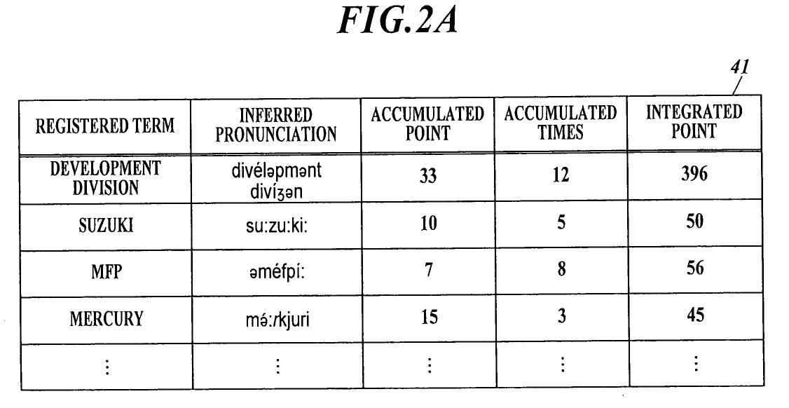

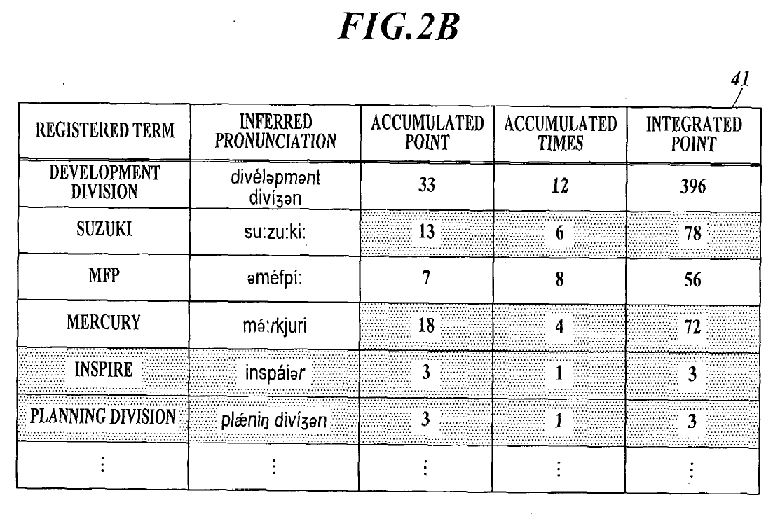

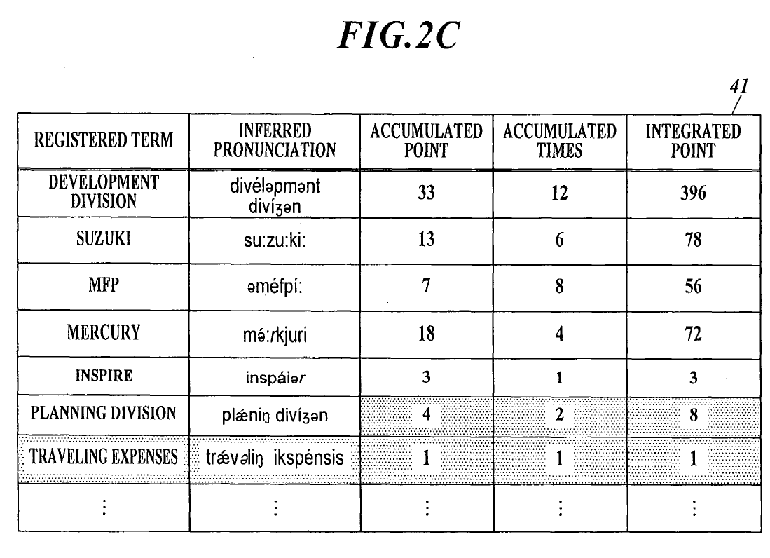

FIG. 2A shows an example of the voice recognition dictionary 41. As shown in FIG. 2A, with respect to the recognition dictionary 41, an inferred pronunciation, an accumulated point, an accumulated times, and an integrated point are provided in connection with each of registered terms.

In the “registered term” of the voice recognition dictionary 41, a sequence of characters of the term, which is obtained by conducting the character recognition of the scan data, is stored. In the “inferred pronunciation”, a pronunciation of a registered term which is inferred by referring to the pronunciation estimation dictionary 44 is stored. In the “accumulated point”, an accumulated value of weighting value, the weighting value being inputted when reading the document that includes the registered term, is stored. In the “accumulated times”, an accumulated value of times that the registered term has been character-recognized is stored. In the “integrated point”, a product of the accumulated point and the accumulated times is stored. The integrated point is used as a priority in determining a recognition result from candidates of term, when voice recognition is conducted by using the voice recognition dictionary 41. That is, in the present embodiment, the priority is determined in accordance with the weighting value which is inputted for a time when reading the document, and the times that the term was character-recognized.

Here, the update of the voice recognition dictionary 41 includes registering a new term, and changing the accumulated point, the accumulated times, the integrated point, and the like of a term that is already registered.

The general voice recognition dictionary 42 is a dictionary which is registered with a term for voice recognition for general use. The general voice recognition dictionary 42 can be stored in the RAM 20 or the ROM 30.

The character recognition dictionary 43 is a general dictionary used for character recognition, in which an image pattern of a character and character data are in connection with each other. The character recognition dictionary 43 can be stored in the RAM 20 or the ROM 30.

The control unit 50 is provided with a hard key, a touch panel and a liquid crystal display (LCD). The hard key is provided with various kinds of keys such as a number key, a start key, a reset key and the like, and outputs a depression signal to the CPU 10 when each key is depressed. The touch panel is formed on the surface of the LCD in combination with the LCD, detects a position where it is touched by a fingertip of a user, a touch pen or the like, and outputs a position signal to the CPU 10. The LCD displays various kinds of operation screens and various kinds of processing results in accordance with an instruction from the CPU 10.

The voice input and output unit 60 is provided with the microphone 61 and a speaker 62. The voice input and output unit 60 converts a voice inputted from the microphone 61 into an electric signal. The voice input and output unit 60 converts an electric signal into a voice and outputs the voice by the speaker 62.

The scanner unit 70 irradiates a document with light, reads a document image by photoelectric conversion of a light that is reflected at the document surface by using a charge coupled device (CCD) line image sensor, and generates scan data.

The printer unit 80 conducts electrophotographic image formation, and is structured with a photoconductive drum, a charging unit to charge the photoconductive drum, an exposing unit to expose the surface of the photoconductive drum in accordance with the image data, a developing unit to adhere toner on the photoconductive drum, a transfer unit to transfer a toner image formed on the photoconductive drum to a paper sheet, and a fixing unit to fix the toner image formed on the paper sheet.

The network control unit 90 is a function unit to connect with the network and to conduct data communication with external devices.

Next, operation will be described.

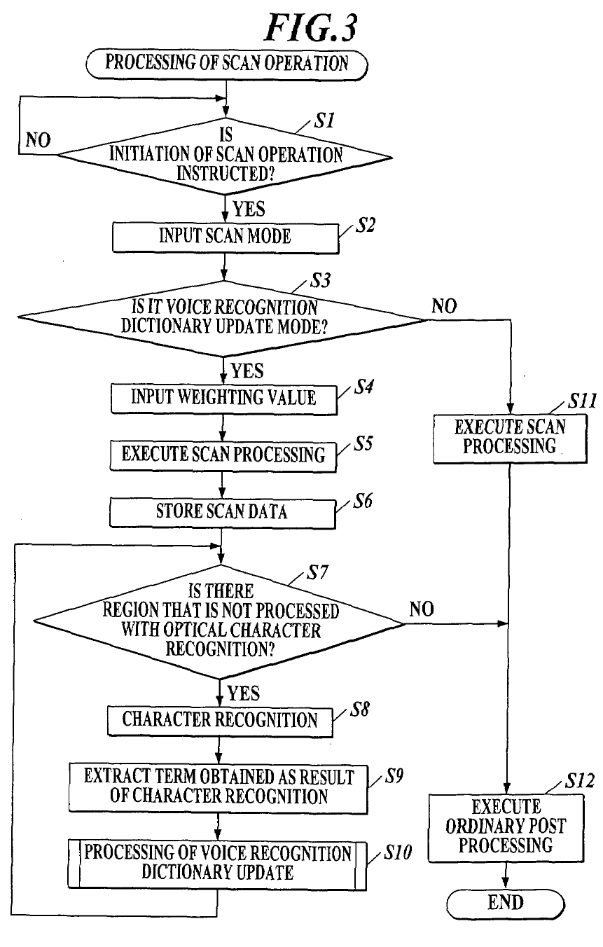

FIG. 3 is a flowchart showing a processing of scan operation executed by the copy machine 100. The processing of scan operation is conducted in a case where copy operation is performed or the copy machine 100 is used as a scanner.

When initiation of scan is instructed by the user depressing the start key of the operation unit 50 (Step S1; Yes), a selection screen to select scan mode is displayed on the operation unit 50. By the operation of the user from the operation unit 50, scan mode is inputted (Step S2). The scan mode includes a voice recognition dictionary update mode and a voice recognition dictionary non-update mode, and one of them is selected. The voice recognition dictionary update mode is a mode in which the voice recognition dictionary 41 is updated in accordance with the result of the character recognition when the processing of scan operation is conducted, and the voice recognition dictionary non-update mode is a mode in which the character recognition is not conducted, and the current voice recognition dictionary 41 is maintained.

In a case where the voice recognition dictionary update mode is selected (Step S3; Yes), an input screen to input a weighting value when a document is read is displayed on the operation unit 50, and input of the weighting value is received by the operation of the user from the operation unit 50 (Step S4). Here, the weighting value ranges from 1 to 3, and the larger the value, the higher the priority when processing the voice recognition.

Subsequently, the document is read by the scanner unit 70 (Step S5), and the scan data is stored in the scan data storage unit 21 (Step S6).

In a case where there is a region, which is not processed with the character recognition, in the scanned data stored in the scan data storage unit 21 (Step S7; Yes), the character recognition dictionary 43 is referred, and the character recognition is conducted for the region (Step S8). Subsequently, by the CPU 10, a term as a result of the character recognition is extracted (Step S9), and is stored in the character recognition data storage unit 22 by the term as one unit.

Next, by the CPU 10, the processing of voice recognition dictionary update is conducted for the term that is character-recognized (Step S10). The processing of the voice recognition dictionary update will be described with reference to FIG. 4.

As shown in FIG. 4, by the CPU 10, it is searched whether a subject term, which was character-recognized, is registered in the “registered term” of the voice recognition dictionary 41 or not (Step S21). In a case where it is registered (Step S22; Yes), a record of the term which is registered, is selected as processing subject (Step S23).

On the other hand, in a case where the subject term is not registered in the “registered term” in the voice recognition dictionary 41 in step S22 (Step S22; No), a new record to make the term as the “registered term” is selected as processing subject by the CPU 10 (Step S24). Subsequently, the CPU 10 once clears the “accumulated point”, the “accumulated times” and the “integrated point” of the newly registered term in the voice recognition dictionary 41 (Step S25). Next, by the CPU 10, a “pronunciation”, which is inferred from the subject term as a key, is obtained in accordance with the pronunciation estimation dictionary 44 (Step S26), and this pronunciation is stored in the “inferred pronunciation” of the subject term (Step S27).

After Step S23 or Step S27, by the CPU 10, a weighting value which is inputted in Step S4 is added to the “accumulated point” of the subject term in the voice recognition dictionary 41 (Step S28), and the “accumulated times” of the subject term is added with 1 (Step S29). Then, product of the “accumulated point” and the “accumulated times” is stored in the “integrated point” (Step S30).

After the processing of the voice recognition dictionary update is completed, as shown in FIG. 3, it returns to Step S7 and the processing of Step S7 through Step S10 is repeated until all of the terms in the scan data are character-recognized.

In Step S3, in a case where the voice recognition dictionary non-update mode is selected (Step S3; No), an ordinary scan processing is conducted by the scan unit 70 (Step S11).

In a case where there is no region that is not processed with the character recognition in Step S7 (Step S7; No), or after Step S11, an ordinary post processing (In a case where it is a processing of copying, image forming processing by the printer unit 80 and the like is processed.) is executed (Step S12).

Accordingly, the processing of scan operation is concluded.

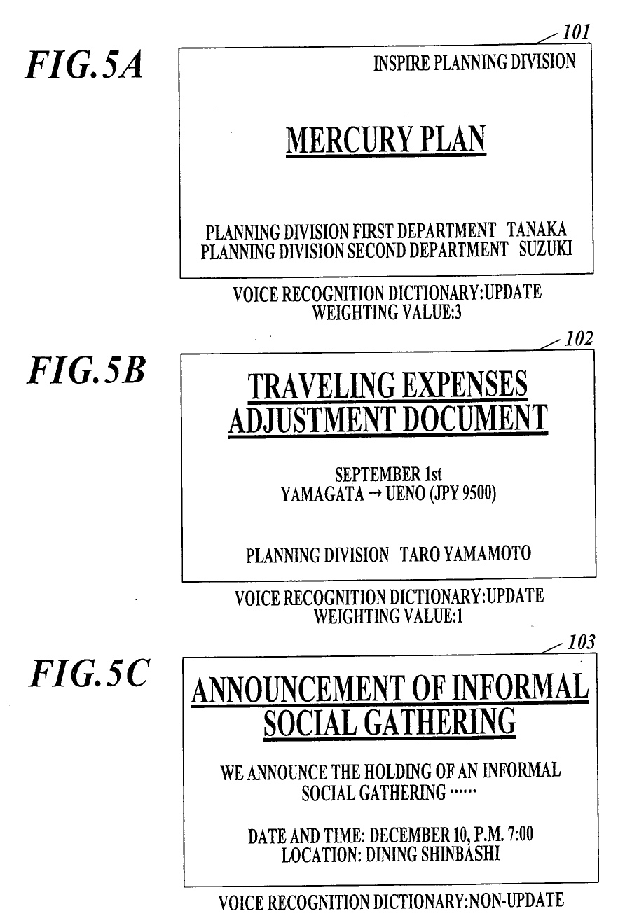

Next, a specific example of updating the voice recognition dictionary 41 is described. Starting with an initial state shown by FIG. 2A, a voice recognition dictionary 41 after a document 101 shown in FIG. 5A is read in a case where the scan mode is the voice recognition dictionary update mode and the weighting value is 3, is shown in FIG. 2B. Each of the terms is character-recognized from the document 101. Terms “inspire” and “planning division”, which were not registered in the initial state of FIG. 2A, are newly registered in the voice recognition dictionary 41. The “accumulated point” is 3, the “accumulated times” is 1, and thus the product of the “accumulated point” and the “accumulated times”, which is 3, is stored in the “integrated point”. With respect to terms such as “Suzuki” and “mercury”, which were registered in the initial state of FIG. 2A, the “accumulated point” is added with 3, the “accumulated times” is added with 1, and product of the “accumulated point” and the “accumulated times” is stored in the “integrated point”.

Starting with the voice recognition dictionary 41 in the state shown by FIG. 2B, a voice recognition dictionary 41 after a document 102 shown in FIG. 5B is read in a case where the scan mode is the voice recognition dictionary update mode and the weighting value is 1, is shown in FIG. 2C. Each of the terms is character-recognized from the document 102. A term “traveling expenses”, which was not registered in the state of FIG. 2B, is newly registered in the voice recognition dictionary 41. The “accumulated point” is 1, the “accumulated times” is 1, and thus the product of the “accumulated point” and the “accumulated times”, which is 1, is stored in the “integrated point”. With respect to a term such as “planning division”, which was registered in the state of FIG. 2B, the “accumulated point” is added with 1, the “accumulated times” is added with 1, and product of the “accumulated point” and the “accumulated times” is stored in the “integrated point”.

Starting with the voice recognition dictionary 41 in the state shown by FIG. 2C, in a case where the scan mode is the voice recognition dictionary non-update mode, the voice recognition dictionary 41 is not updated and maintains the state of FIG. 2C after a document 103 shown in FIG. 5C is read.

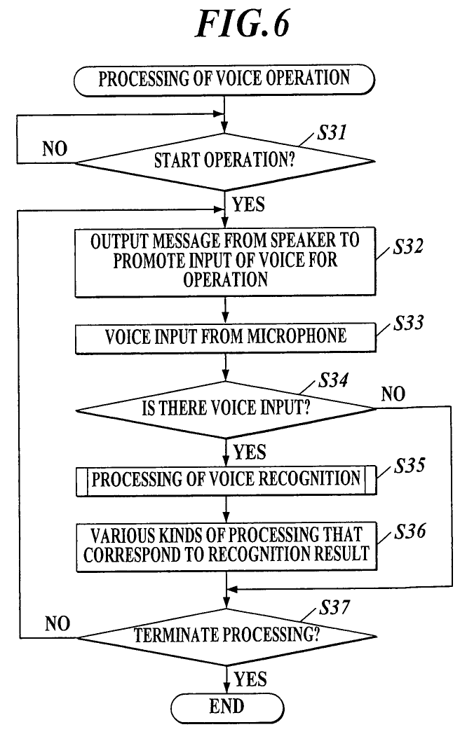

Next, a processing or voice operation will be described with reference to FIG. 6.

First of all, when an operation is initiated at the copy machine 100 (Step S31; Yes), a message that promotes voice input for operation is outputted from the speaker 62 of the voice input and output unit 60 (Step S32), and voice input of the user is received from the microphone 61 (Step S33).

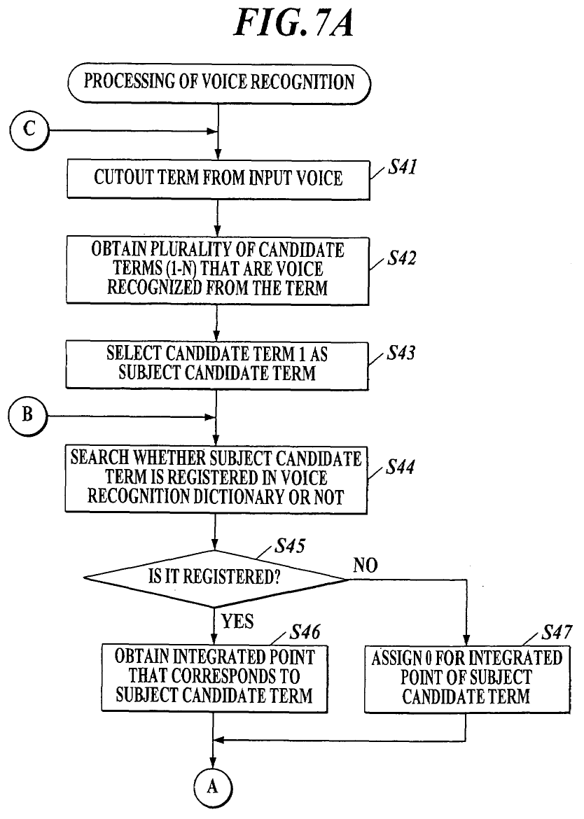

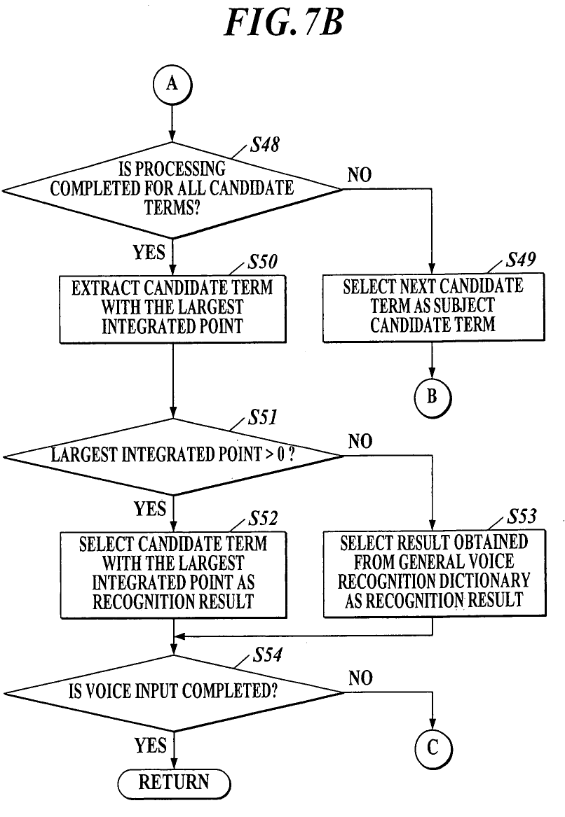

In a case where there was a voice input (Step S34; Yes), the processing of the voice recognition is conducted by the CPU 10 (Step S35). Here, the processing of the voice recognition is described with reference to FIG. 7.

As shown in FIGS. 7A and 7B, by the CPU 10, a term is cut out from a voice which is inputted through the microphone 61 (Step S41), voice recognition is conducted by referring to the general voice recognition dictionary 42, and a plurality of candidate terms (candidate term 1 through n (n is an integer)) that may match the inputted voice are obtained (Step S42).

First of all, by the CPU 10, candidate term 1 is selected as a subject candidate term (Step S43), and search is performed to find whether the subject candidate term is registered in the voice recognition dictionary 41 or not (Step S44). In a case where the subject candidate term is registered in the voice recognition dictionary 41 (Step S45; Yes), an integrated point that corresponds to the subject candidate term is obtained from the voice recognition dictionary 41 by the CPU 10 (Step S46). In a case where the subject candidate term is not registered in the voice recognition dictionary 41 (Step S45; No), 0 is assigned for the integrated point of the subject candidate term by the CPU 10 (Step S47).

Then, the CPU 10 determines whether the processing is completed for all the candidate terms or not (Step S48). In a case where there is a candidate term for which the processing is not completed (Step S48; No), the next candidate term is selected as the subject candidate term by the CPU 10 (Step S49), and returns to Step S44.

In Step S48, in a case where the processing is completed for all of the candidate terms (Step S48; Yes), a candidate term with the largest integrated point is extracted by the CPU 10 (Step S50). In a case where the maximum value of the integrated point of the candidate term is larger than 0 (Step S51; Yes), the CPU 10 chooses the candidate term with the largest integrated point as the recognition result (Step S52).

In step S51, in a case where the maximum value of the integrated point is 0 (Step S51; No), that is, in a case where there is no candidate term, which is registered in the voice recognition dictionary 41, among the plurality of candidate terms, the CPU 10 selects the most suitable term, which is searched among the general terms by using the general voice recognition dictionary 42, as the recognition result (Step S53).

After Step S52 or Step S53, in a case where voice input is not completed (Step S54; No), it returns to Step S41 and repeats the processing of Step S41 through Step S54.

In Step S54, in a case where voice input is completed (Step S54; Yes), it returns to FIG. 6 and various kinds of processing that correspond to recognition result is conducted by the CPU 10 (Step S36).

After Step S36 or in a case where there is no voice input in Step S34 (Step S34; No), the CPU 10 determines whether to terminate the processing or not (Step S37). In a case where the processing is not terminated (Step S37; No), it returns to Step S32.

In Step S37, in a case where the processing is terminated (Step S37; Yes), the processing of the voice operation is terminated.

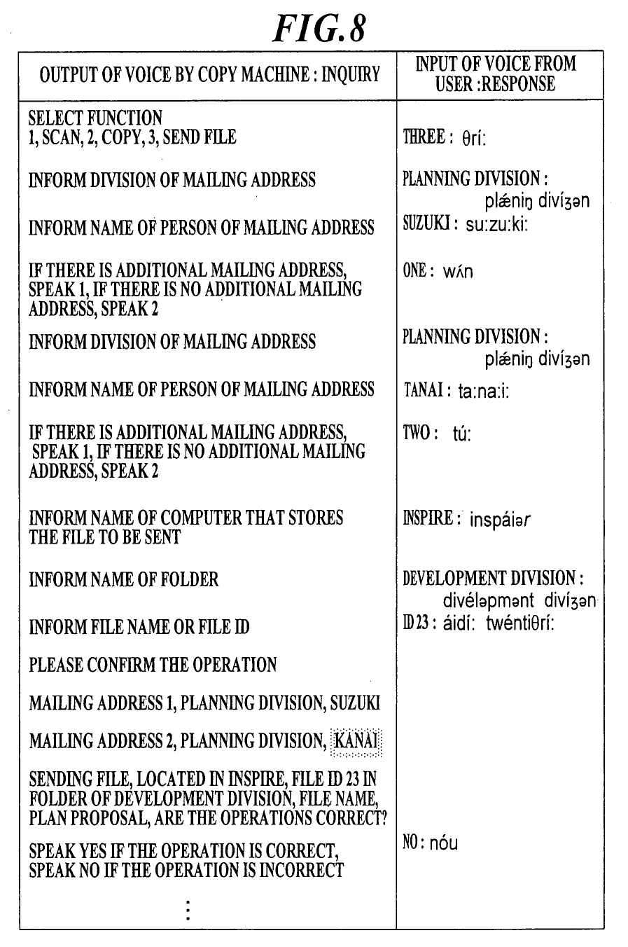

With reference to FIG. 8, a specific example of voice operation in a case where the user sends a file in a folder “development division”, which is in a server “inspire”, to “Suzuki” and “Tanai”, who belong to “planning division”, by mail will be described. Left column of FIG. 8 is an inquiry from the copy machine 100, and right column of FIG. 8 is a reply from the user. Here, when voice recognition is conducted, the voice recognition dictionary 41 shown in FIG. 2C is used.

As shown in FIG. 8, first of all, an inquiry to allow the user to select a function (scan, copy, send file) is outputted by voice from the speaker 62 of the copy machine 100, and “three (send file)” is inputted by voice from the microphone 61 as a reply from the user. Subsequently, inquiries with respect to division of mailing address, name of a person of the mailing address, name of the computer in which the file is stored, name of folder and file ID (or file name) are outputted by voice from the speaker 62 of the copy machine 100, and a response of the user is inputted by voice from the microphone 61.

Subsequently, a message to confirm the operation detail is outputted by voice from the speaker 62 of the copy machine 100. In this example, terms such as “inspire”, “planning division”, “Suzuki” and the like have high recognition degree since they are registered in the voice recognition dictionary 41, and are thus recognized correctly. However, since the name “Tanai” was not registered, it is misrecognized as “Kanai”.

As described above, according to the copy machine 100, since the voice recognition dictionary 41 is updated in accordance with a character recognition result of a term which is included in a document, a voice recognition dictionary 41 which is suitable for usage environment can be constructed or compiled. Further, since the integrated point, which is used as priority when processing the voice recognition of a term, is determined in accordance with number of times that the term is character-recognized, the more frequently the term is included in a document, the more easily the term is recognized as the voice recognition result. Since the integrated point, which is used as priority when processing the voice recognition of a term, is determined in accordance with a weighting value which is inputted when the document is read, the larger the weighting value of the document that includes the term is, the more easily the term is recognized as the voice recognition result.

In the present embodiment, during the use of the copy machine 100 in daily task, the voice recognition dictionary 41 is updated with a term that is included in the document as “a term that is likely to be used frequently”. Therefore, recognition degree of a term that is frequently used in the usage environment (workplace and the like) can be improved. As a result, the overall voice recognition degree, including proper nouns and special terms that are used specifically for a certain environment, can be improved.

Here, the description with respect to the above embodiment is an example of a voice recognition dictionary construction apparatus according to the present invention, and is not limited to the description given above. Specific structures and specific operations with respect to each unit that structures the apparatus can be arbitrarily modified so long as it does not deviate the scope of the invention.

In the afore-mentioned embodiment, the integrated point, which is a product of the accumulated point and the accumulated times, was used as a priority to be used when processing the voice recognition. However, either one of the accumulated point or the accumulated times may be used as the priority to be used when processing the voice recognition. Further, the recognition degree may be determined by taking parameters other than the accumulated point and the accumulated times into consideration.

The user may be able to arbitrarily edit the contents of the voice recognition dictionary 41, such as deleting a term that is unnecessary from the voice recognition dictionary 41, correcting the pronunciation in a case where the pronunciation turns out to be wrong by referring to the pronunciation estimation dictionary 44, and the like.

In the afore-mentioned embodiment, a case where all of the users of the copy machine 100 use the voice recognition dictionary 41 in common was described. However, other than the voice recognition dictionary 41 in common, an individual voice recognition dictionary may be provided for each user, and only a term which is frequently used by a particular user may be used when processing voice recognition with respect to that particular user. In such case, since the term which is frequently used by the particular user is generally pertinent to work tasks and inclination of that particular user, there is a fear that confidentiality of an organization may be leaked by analyzing the individual voice recognition dictionary for each user. Therefore, it is preferable to provide a measure to prohibit the individual voice recognition dictionary for each user from being referred to by another user, and improve security.

For example, the individual voice recognition dictionary for each user may be managed in connection with identification information or a password that is specific to a user. In such case, when a document is read, a user can be qualified to update a voice recognition dictionary that corresponds to the user, by selecting the voice recognition dictionary update mode and inputting identification information or a password. In a case where the identification information or the password is incorrect, update of the voice recognition dictionary is not conducted, or it is processed as an error.

A voiceprint of each user may be registered, and a user may be identified by comparing the registered voiceprint with a voice that is inputted when processing the voice operation. In a case where the user is identified, voice recognition is processed by using the voice recognition dictionary that corresponds to the identified user, and in a case where the user is not identified, voice operation is rejected, the general voice recognition dictionary 42 is used, or is processed as an error.

What is claimed is:

1. A voice recognition dictionary construction apparatus, comprising:
a scanner unit to read a document; and
a control unit to conduct character recognition of a term which is included in the document that has been read, and to update a dictionary for voice recognition in accordance with a result of the character recognition.

2. The voice recognition dictionary construction apparatus of claim 1, wherein the control unit determines a priority in a voice recognition of the term, in accordance with a number of times that the term has been character-recognized.

3. The voice recognition dictionary construction apparatus of claim 1, further comprising:
an operation unit to receive input of a weighting value for a time when the document is read, wherein
the control unit determines a priority in a voice recognition of the term, in accordance with the weighting value.

4. A computer readable medium which stores a program, the program causing a computer to realize:
a control function to conduct character recognition of a term which is included in a document that has been read by an optical reading unit, and to update a dictionary for voice recognition in accordance with a result of the character recognition.

5. The computer readable medium of claim 4, wherein the control function determines a priority in the voice recognition of the term, in accordance with a number of times that the term has been character-recognized.

6. The computer readable medium of claim 4, further causing a computer to realize:
a receiving function to receive input of a weighting value for a time when the document is read, wherein
the control function determines a priority in a voice recognition of the term, in accordance with the weighting value.
